(19) United States
(12) Patent Application Publication
(10) Pub. No.: US 2016/0013747 A1
(43) Pub. Date: Jan. 14, 2016

(54) MOTOR DRIVING CONTROL APPARATUS AND METHOD, AND MOTOR SYSTEM USING THE SAME

(71) Applicant: SAMSUNG ELECTRO-MECHANICS CO., LTD., Suwon-Si (KR)

(72) Inventor: Bon Young GU, Suwon-Si (KR)

(21) Appl. No.: 14/502,984

(22) Filed: Sep. 30, 2014

(30) Foreign Application Priority Data
Jul. 11, 2014 (KR) 10-2014-0087771

(51) Int. Cl. H02P 23/14; H02P 6/18; G01P 3/495

(52) U.S. Cl. CPC H02P 23/14; G01P 3/495; H02P 6/18

(57) ABSTRACT

The motor driving control apparatus may include: a speed-position detecting unit detecting an angular velocity and a magnetic flux angle of a rotor of a motor apparatus using currents flowing in a plurality of phases of the motor apparatus; a magnetic flux angle correcting unit determining a reference magnetic flux angle using the magnetic flux angle and outputting the reference magnetic flux angle when an error is present in the magnetic flux angle; and a controlling unit controlling driving of the motor apparatus using the angular velocity and the magnetic flux angle.

### CROSS-REFERENCE TO RELATED APPLICATION

This application claims the benefit of Korean Patent Application No. 10-2014-0087771 filed on Jul. 11, 2014, with the Korean Intellectual Property Office, the disclosure of which is incorporated herein by reference.

### BACKGROUND

The present disclosure relates to a motor driving control apparatus and a method capable of increasing accuracy in motor driving by correcting distortions occurring in a magnetic flux angle, and a motor system using the same.

In accordance with the development of a motor technology, motors having various sizes have been used in various technical fields.

Generally, motors are driven by rotating a rotor using a permanent magnet and a coil having polarities changed depending on a current applied thereto. One initial motor is a brush type motor having a coil disposed on a rotor. However, brush type motors may be problematic in that brushes thereof may be worn out or sparking may occur due to the driving of the motor.

For this reason, various types of brushless motor have come into common use recently. A brushless motor is a direct current (DC) motor driven using an electronic commutation mechanism instead of mechanical contact parts such as a brush, a commutator, and the like. The brushless motor may generally include a stator including coils corresponding to a plurality of phases and generating magnetic force by phase voltages of the respective coils and a rotor formed of a permanent magnet and rotated by the magnetic force of the stator.

In order to control the driving of the brushless motor, it is necessary to confirm rotor information so as to alternately provide the phase voltages. In order to confirm a position of the rotor, rotor information, for example, angular velocity or a magnetic flux angle may be detected using a hall sensor or back electromotive force, and such motors may be driven based on the rotor information detected as described above.

However, in the related art as described above, in the case in which an error occurs in the rotor information, an error is reflected as is, such that accuracy in motor control may be decreased. Particularly, in the case in which the magnetic flux angle of the rotor is abnormally detected, when the motor control is performed using the magnetic flux angle in which an error is reflected, a torque ripple appears, efficiency of the motor is decreased, and noise is increased.

The following Related Art Documents, which relate to the motor technology as described above, have a limitation that they do not solve the above-mentioned problems.

### RELATED ART DOCUMENT

(Patent Document 1) Korean Patent Laid-Open Publication No. 1999-0058749
(Patent Document 2) Korean Patent Laid-Open Publication No. 2012-0079375

### SUMMARY

An exemplary embodiment in the present disclosure may provide a motor driving control apparatus and a method capable of increasing accuracy in driving of a motor apparatus and significantly decreasing a torque ripple by generating a reference magnetic flux angle from a detected magnetic flux angle and driving a motor using the reference magnetic flux angle in the case in which distortion is present in the magnetic flux angle, and a motor system using the same.

According to an exemplary embodiment in the present disclosure, a motor driving control apparatus may include: a speed-position detecting unit detecting an angular velocity and a magnetic flux angle of a rotor of a motor apparatus using currents flowing in a plurality of phases of the motor apparatus; a magnetic flux angle correcting unit determining a reference magnetic flux angle using the magnetic flux angle and outputting the reference magnetic flux angle when an error is present in the magnetic flux angle; and a controlling unit controlling driving of the motor apparatus using the angular velocity and the magnetic flux angle.

According to an exemplary embodiment in the present disclosure, a motor system may include: a motor apparatus performing a rotation operation depending on a driving signal; and a motor driving control apparatus detecting an angular velocity and a magnetic flux angle of a rotor of the motor apparatus and generating the driving signal using a reference magnetic flux angle when an error is present in the magnetic flux angle.

According to an exemplary embodiment in the present disclosure, a motor driving control method performed by a motor driving control apparatus controlling driving of a motor apparatus may include: detecting an angular velocity and a magnetic flux angle of a rotor of the motor apparatus using currents flowing in a plurality of phases of the motor apparatus; determining a reference magnetic flux angle using the magnetic flux angle; and controlling the driving of the motor apparatus using the reference magnetic flux angle when an error is present in the magnetic flux angle.

In summary, all features are not mentioned. Various means for solving an object in the present disclosure may be understood in more detail with reference to specific exemplary embodiments of the following detailed description.

### BRIEF DESCRIPTION OF DRAWINGS

The above and other aspects, features and other advantages in the present disclosure will be more clearly understood from the following detailed description taken in conjunction with the accompanying drawings, in which:

FIG. 1 is a configuration diagram illustrating a motor system according to an exemplary embodiment in the present disclosure;

FIG. 2 is a graph showing an example of a magnetic flux angle in a normal state;

FIG. 3 is a graph showing an example of a magnetic flux angle in which an error is present;

FIG. 4 is a configuration diagram illustrating an example of a magnetic flux angle correcting unit of FIG. 1; and

FIG. 5 is a flowchart illustrating a motor driving control method according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

In addition, hereinafter, a motor device will be known as a motor apparatus 200, and a system including a motor driving control apparatus 100 for driving the motor apparatus 200 and the motor apparatus 200 will be known as a motor system.

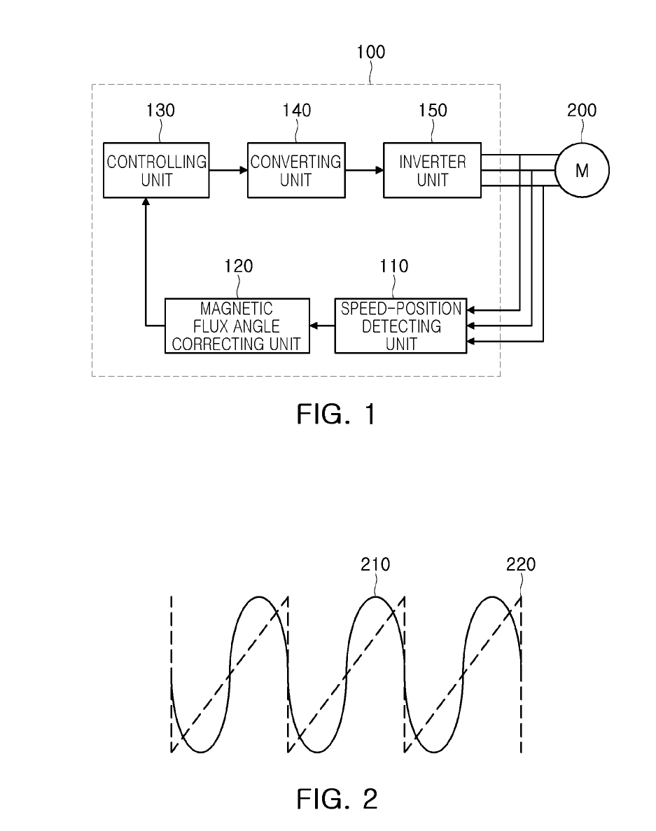

FIG. 1 is a configuration diagram illustrating a motor system according to an exemplary embodiment in the present disclosure.

The motor apparatus 200 may perform a rotation operation depending on a driving signal. For example, the respective coils of the motor apparatus 200 may generate magnetic fields by a driving current (driving signal) provided from an inverter unit 150. A rotor included in the motor apparatus 200 may rotate by the magnetic fields generated by the coils.

The motor driving control apparatus 100 may provide a predetermined signal, for example, the driving signal, to the motor apparatus 200 to control the rotation operation of the motor apparatus 200.

The motor driving control apparatus 100 may detect an angular velocity and a magnetic flux angle of the rotor of the motor apparatus 200 and generate the driving signal using a reference magnetic flux angle in the case that an error is present in the magnetic flux angle.

In more detail, the motor driving control apparatus 100 may include a speed-position detecting unit 110, a magnetic flux angle correcting unit 120, a controlling unit 130, a converting unit 140, and an inverter unit 150.

The speed-position detecting unit 110 may detect the angular velocity and the magnetic flux angle of the rotor of the motor apparatus 200 using currents flowing in a plurality of phases of the motor apparatus 200.

In an exemplary embodiment in the present disclosure, the speed-position detecting unit 110 may detect back electromotive force induced in the plurality of phases of the motor apparatus 200 and detect the magnetic flux angle using the back electromotive force.

The magnetic flux angle correcting unit 120 may determine the reference magnetic flux angle using the magnetic flux angle and output the reference magnetic flux angle when an error is present in the magnetic flux angle. An error in the magnetic flux angle may be corrected by the magnetic flux angle correcting unit 120.

Various examples of the magnetic flux angle correcting unit 120 will be described in more detail below with reference to FIGS. 2 through 4.

The controlling unit 130 may control the driving of the motor apparatus 200 using the angular velocity and the magnetic flux angle. The controlling unit 130 may generate a control signal based on a command speed input from the outside.

The converting unit 140 may convert the control signal input from the controlling unit 130 into the driving signal and output the driving signal. According to an exemplary embodiment in the present disclosure, the converting unit 140 may perform coordinate conversion for a vector control.

The inverter unit 150 may apply a driving current corresponding to the input driving signal to each phase of the motor apparatus 200.

FIG. 2 is a graph showing an example of a magnetic flux angle and a phase current depending on the magnetic flux angle.

Since back electromotive force appearing in each phase of the motor apparatus 200 has a sinusoidal form, a magnetic flux angle 220 may appear in a form of a saw-tooth wave linear function from 0 to 360 degrees as shown in FIG. 2.

The magnetic flux angle 220 in which an error is not present is shown in FIG. 2. Therefore, it may be appreciated that a phase current 210 generated by the magnetic flux angle has a sinusoidal form.

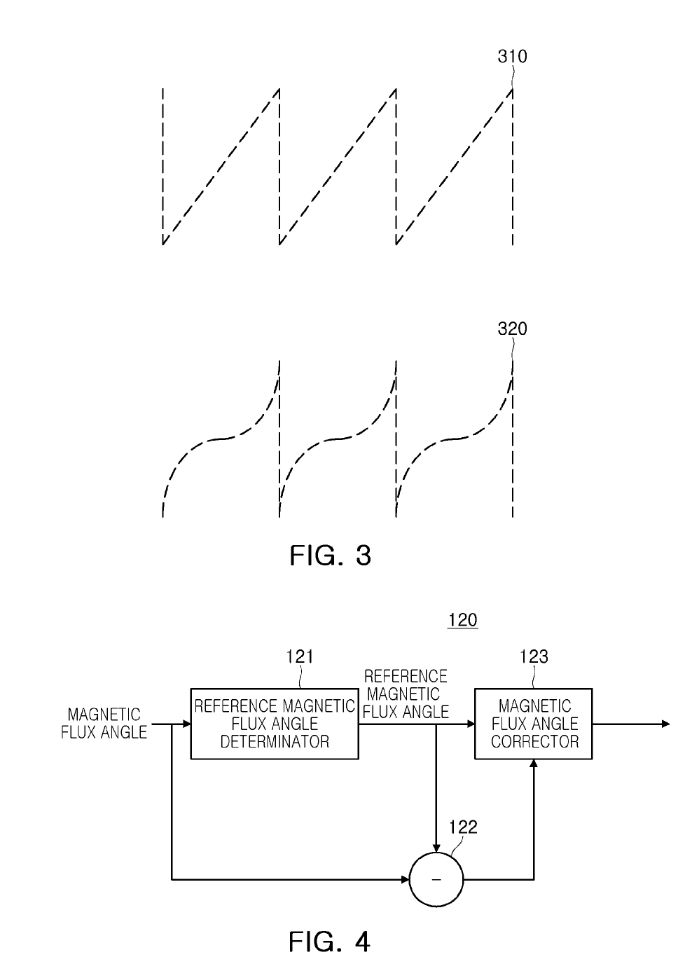

However, an error may be reflected in the magnetic flux angle due to an error in calculation, an error in analog-to-digital conversion, an error in a motor parameter, and the like. FIG. 3 is a graph showing an example of a magnetic flux angle in a normal state and a magnetic flux angle in a state in which an error is present.

It may be appreciated that a magnetic flux angle 310 shown at an upper end of FIG. 3 has a normal state, while predetermined distortion occurs at a magnetic flux angle 320 shown at a lower end of FIG. 3. That is, it may be appreciated that a saw-tooth wave does not have a feature of a linear function, that is, linearity.

An error in the magnetic flux angle as described above may be reflected in the driving signal. Therefore, pulsation, a torque ripple, or the like, of the motor apparatus 200 may occur.

Therefore, the magnetic flux angle correcting unit 120 may confirm whether an error is present in the input magnetic flux angle.

In an exemplary embodiment in the present disclosure, the magnetic flux angle correcting unit 120 may judge that an error is present in the input magnetic flux angle when the input magnetic flux angle does not have linearity. That is, in the case in which an increase rate of the input magnetic flux angle from 0 degree to 360 degrees does not have linearity (for example, the magnetic flux angle 320 shown at the lower end of FIG. 3), the magnetic flux angle correcting unit 120 may judge that an error is present in the input magnetic flux angle.

In an exemplary embodiment in the present disclosure, the magnetic flux angle correcting unit 120 may determine the reference magnetic flux angle. The reference magnetic flux angle, which corresponds to a magnetic flux angle in an ideal state, may be output by the magnetic flux angle correcting unit 120 in the case in which an error is present in the input magnetic flux angle.

In an exemplary embodiment in the present disclosure, the magnetic flux angle correcting unit 120 may determine that the input magnetic flux angle is the reference magnetic flux angle when the input magnetic flux angle has linearity.

In another exemplary embodiment in the present disclosure, the magnetic flux angle correcting unit 120 may confirm a first value of 0 degree and a second value of 360 degrees of the input magnetic flux angle when the input magnetic flux angle does not have linearity, and may determine that a saw-tooth wave having the first value as a minimum value and having the second value as a maximum value is the reference magnetic flux angle. That is, in the case in which an error is present in the input magnetic flux angle, the magnetic flux angle correcting unit 120 may determine that a saw-tooth wave linearly connecting a value of 0 degree and a value of 360 degrees of the input magnetic flux angle to each other is the reference magnetic flux angle.

FIG. 4 is a configuration diagram illustrating an example of a magnetic flux angle correcting unit of FIG. 1.

As shown in FIG. 4, the magnetic flux angle correcting unit 120 may include a reference magnetic flux angle determinator 121, a subtractor 122, and a magnetic flux angle corrector 123.

The reference magnetic flux angle determinator 121 may determine the reference magnetic flux angle using the input magnetic flux angle.

In an exemplary embodiment in the present disclosure, the reference magnetic flux angle determinator 121 may determine that the input magnetic flux angle is the reference magnetic flux angle when the input magnetic flux angle has linearity.

In another exemplary embodiment in the present disclosure, the reference magnetic flux angle determinator 121 may confirm the first value of 0 degree and the second value of 360 degrees of the input magnetic flux angle when the input magnetic flux angle does not have linearity, and may determine that the saw-tooth wave having the first value as the minimum value and having the second value as the maximum value is the reference magnetic flux angle.

The subtractor 122 may receive the magnetic flux angle and the reference magnetic flux angle and output a difference between the magnetic flux angle and the reference magnetic flux angle.

The magnetic flux angle corrector 123 may output the reference magnetic flux angle when an output of the subtractor, that is, the difference between the magnetic flux angle and the reference magnetic flux angle is equal to a preset threshold value or less. Alternatively, the magnetic flux angle corrector 123 may output the input magnetic flux angle when the difference is equal to the preset threshold value or more. This may be to judge whether distortion present in the magnetic flux angle is due to an error or is due to a change in a driving speed.

That is, in the case in which the difference is higher than the preset threshold value, the magnetic flux angle corrector 123 may judge that the distortion occurs at the magnetic flux angle due to the change in the driving speed to output the input magnetic flux angle. Meanwhile, in the case in which the difference is lower than the preset threshold value, the magnetic flux angle corrector 123 may judge that the distortion occurs in the magnetic flux angle due to an error to output the reference magnetic flux angle.

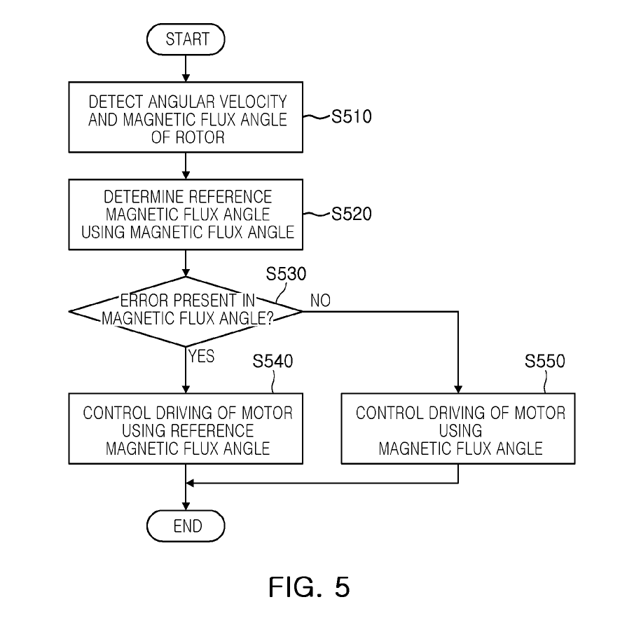

FIG. 5 is a flow chart illustrating a motor driving control method according to an exemplary embodiment in the present disclosure.

Hereinafter, a motor driving control method according to an exemplary embodiment in the present disclosure will be described with reference to FIG. 5. Since the motor driving control method according to an exemplary embodiment in the present disclosure is performed in the motor driving control apparatus 100 described above with reference to FIGS. 1 through 4, a description for contents that are the same as or correspond to the above-mentioned contents will be omitted.

Referring to FIG. 5, the motor driving control apparatus 100 may detect the angular velocity and the magnetic flux angle of the rotor of the motor apparatus 200 using the currents flowing in the plurality of phases of the motor apparatus 200 (S510).

Then, the motor driving control apparatus 100 may determine the reference magnetic flux angle using the magnetic flux angle (S520), and control the driving of the motor apparatus using the reference magnetic flux value (S540) when an error is present in the magnetic flux angle (S530).

In an example of S530, the motor driving control apparatus 100 may judge that an error is present in the magnetic flux angle when the magnetic flux angle does not have linearity.

In an example of S520, the motor driving control apparatus 100 may determine that the magnetic flux angle is the reference magnetic flux angle when the magnetic flux angle has linearity.

In another example of S520, the motor driving control apparatus 100 may confirm the first value of 0 degree and the second value of 360 degrees of the magnetic flux angle when the magnetic flux angle does not have linearity, and may determine that a saw-tooth wave having the first value as the minimum value and having the second value as the maximum value is the reference magnetic flux angle.

The motor driving control apparatus 100 may control the driving of the motor apparatus using the magnetic flux angle (S550) when an error is not present in the magnetic flux angle (S530).

As set forth above, according to exemplary embodiments in the present disclosure, the reference magnetic flux angle is generated form the detected magnetic flux angle, and the motor is driven using the reference magnetic flux angle in the case in which the distortion is present in the magnetic flux angle, whereby accuracy in the driving of the motor apparatus may be increased and a torque ripple may be significantly decreased.

While exemplary embodiments have been shown and described above, it will be apparent to those skilled in the art that modifications and variations could be made without departing from the scope of the invention as defined by the appended claims.

What is claimed is:

1. A motor driving control apparatus comprising:
a speed-position detecting unit detecting an angular velocity and a magnetic flux angle of a rotor of a motor apparatus using currents flowing in a plurality of phases of the motor apparatus;
a magnetic flux angle correcting unit determining a reference magnetic flux angle using the magnetic flux angle and outputting the reference magnetic flux angle when an error is present in the magnetic flux angle; and
a controlling unit controlling driving of the motor apparatus using the angular velocity and the magnetic flux angle.

2. The motor driving control apparatus of claim 1, wherein the magnetic flux angle correcting unit judges that an error is present in the magnetic flux angle when the magnetic flux angle does not have linearity.

3. The motor driving control apparatus of claim 1, wherein the magnetic flux angle correcting unit determines that the magnetic flux angle is the reference magnetic flux angle when the magnetic flux angle has linearity.

4. The motor driving control apparatus of claim 3, wherein the magnetic flux angle correcting unit confirms a first value of 0 degree and a second value of 360 degrees of the magnetic flux angle when the magnetic flux angle does not have linearity, and determines that a saw-tooth wave having the first value as a minimum value and having the second value as a maximum value is the reference magnetic flux angle.

5. The motor driving control apparatus of claim 1, wherein the magnetic flux angle correcting unit includes:
a reference magnetic flux angle determinator determining the reference magnetic flux angle using the magnetic flux angle;
a subtractor receiving the magnetic flux angle and the reference magnetic flux angle and outputting a difference between the magnetic flux angle and the reference magnetic flux angle; and
a magnetic flux angle corrector outputting the reference magnetic flux angle when the difference is equal to a preset threshold value or less.

6. The motor driving control apparatus of claim 5, wherein the magnetic flux angle corrector outputs the magnetic flux angle when the difference is equal to the preset threshold value or more.

7. A motor system comprising:
a motor apparatus performing a rotation operation depending on a driving signal; and
a motor driving control apparatus detecting an angular velocity and a magnetic flux angle of a rotor of the motor apparatus and generating the driving signal using a reference magnetic flux angle when an error is present in the magnetic flux angle.

8. The motor system of claim 7, wherein the motor driving control apparatus includes:
a speed-position detecting unit detecting the angular velocity and the magnetic flux angle using currents flowing in a plurality of phases of the motor apparatus;
a magnetic flux angle correcting unit determining the reference magnetic flux angle using the magnetic flux angle and outputting the reference magnetic flux angle when an error is present in the magnetic flux angle; and
a controlling unit controlling driving of the motor apparatus using the angular velocity and the magnetic flux angle.

9. The motor system of claim 8, wherein the magnetic flux angle correcting unit judges that an error is present in the magnetic flux angle when the magnetic flux angle does not have linearity.

10. The motor system of claim 8, wherein the magnetic flux angle correcting unit determines that the magnetic flux angle is the reference magnetic flux angle when the magnetic flux angle has linearity.

11. The motor system of claim 10, wherein the magnetic flux angle correcting unit confirms a first value of 0 degree and a second value of 360 degrees of the magnetic flux angle when the magnetic flux angle does not have linearity, and determines that a saw-tooth wave having the first value as a minimum value and having the second value as a maximum value is the reference magnetic flux angle.

12. The motor system of claim 8, wherein the magnetic flux angle correcting unit includes:
a reference magnetic flux angle determinator determining the reference magnetic flux angle using the magnetic flux angle;
a subtractor receiving the magnetic flux angle and the reference magnetic flux angle and outputting a difference between the magnetic flux angle and the reference magnetic flux angle; and
a magnetic flux angle corrector outputting the reference magnetic flux angle when the difference is equal to a preset threshold value or less.

13. The motor system of claim 12, wherein the magnetic flux angle corrector outputs the magnetic flux angle when the difference is equal to the preset threshold value or more.

14. A motor driving control method performed by a motor driving control apparatus controlling driving of a motor apparatus, the motor driving control method comprising:
detecting an angular velocity and a magnetic flux angle of a rotor of the motor apparatus using currents flowing in a plurality of phases of the motor apparatus;
determining a reference magnetic flux angle using the magnetic flux angle; and
controlling the driving of the motor apparatus using the reference magnetic flux angle when an error is present in the magnetic flux angle.

15. The motor driving control method of claim 14, wherein the controlling of the driving of the motor apparatus includes judging that an error is present in the magnetic flux angle when the magnetic flux angle does not have linearity.

16. The motor driving control method of claim 14, wherein the determining of the reference magnetic flux angle includes determining that the magnetic flux angle is the reference magnetic flux angle when the magnetic flux angle has linearity.

17. The motor driving control method of claim 16, wherein the determining of the reference magnetic flux angle includes confirming a first value of 0 degree and a second value of 360 degrees of the magnetic flux angle when the magnetic flux angle does not have linearity, and determining that a saw-tooth wave having the first value as a minimum value and having the second value as a maximum value is the reference magnetic flux angle.
